(19) United States
(12) Patent Application Publication
(10) Pub. No.: US 2010/0033562 A1
(43) Pub. Date: Feb. 11, 2010

(54) METHOD OF MAPPING CONDITIONS IN A LIQUID STORAGE TANK

(76) Inventor: Penny Allds, Pleasant Shade, TN (US)

Correspondence Address: LUEDEKA, NEELY & GRAHAM, P.C., P O BOX 1871, KNOXVILLE, TN, 37901, US

(21) Appl. No.: 12/536,529

(22) Filed: Aug. 6, 2009

Related U.S. Application Data
(60) Provisional application No. 61/086,921, filed on Aug. 7, 2008.

(51) Int. Cl. H04N 7/18; G06F 19/00

(52) U.S. Cl. 348/82; 701/2; 348/E07.085

(57) ABSTRACT

A method of mapping characteristics of a stored liquid and the liquid storage tank in which the liquid is stored us a remotely operated vehicle. Steps of the method include (a) maneuvering the ROV through a stored liquid, (b) recording camera-based data; and recording sensor-based data. The recorded data is preferably synchronized to gain a map of the characteristics in the storage tank.

### CROSS-REFERENCE(S) TO RELATED APPLICATION(S)

This is a nonprovisional utility application claiming priority to pending U.S. Provisional Application Ser. No. 61/086,921 filed on Aug. 7, 2008, entitled METHOD FOR MAPPING CONDITIONS IN A WATER STORAGE TANK, all of which is incorporated herein by reference in its entirety.

### STATEMENT REGARDING NOTICE OF COPYRIGHT

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### FIELD

This disclosure relates to the field of liquid storage. More particularly, this disclosure relates to a method for mapping the condition of liquid in a liquid storage tank and/or the condition of the internal tank structure.

### BACKGROUND

Liquid is often provided or supplemented using various types of liquid storage tanks. Such tanks may, for example, store water for human use (e.g., bathing and consumption), industrial use (e.g., cooling and heating), fire suppression, and/or agriculture use. Liquid tanks may include, for example, elevated liquid storage tanks or ground liquid storage tanks. The behaviors of various liquids in various types of tanks are often modeled and various mathematical or other theoretical liquid behavior models have been relied upon to indicate the behavior of an actual particular liquid in such tanks. However, the behavior and condition of liquid stored in liquid storage tanks are often dynamic and unpredictable. In short, there is no substitute for empirical data. Moreover, in certain liquid storage applications such as, for example, potable water, some degree of reported empirical data regarding the water and/or tank conditions are often required under state and federal laws and regulations.

For example, in the late 1990's, the State of Tennessee mandated that potable water storage tanks be inspected and a report be posted in a maintenance file for each tank at least once every five years. See RULES OF TENNESSEE DEPARTMENT OF ENVIRONMENT AND CONSERVATION BUREAU OF ENVIRONMENT DIVISION OF WATER SUPPLY, Section 1200-5-1-.17(33). The report(s) must include “the sanitary, coating and structural conditions of the tank; and all recommendations for needed maintenance activities.” Other state governments have enacted similar laws and rules. Thus, at least for states which require periodic data sampling, theoretical modeling is no longer sufficient to meet the requirements of state rules.

What is needed, therefore, is a reliable, safe, and efficient method to create a comprehensive report on the conditions within a liquid storage tank including gathering visual, physical, and chemical data throughout liquid that is stored therein. More specifically, what is needed is a method to gather multiple types of data substantially simultaneously while obtaining video information of the interior of a liquid storage tank, thereby creating a multi-dimensional map of the conditions within an actual liquid storage tank.

### SUMMARY

The above and other needs are met by a method of mapping a plurality of characteristics of a three-dimensional space substantially occupied by liquid within a liquid storage tank using a submersible remotely operated vehicle (ROV) equipped with a plurality of information collection components. In a preferred embodiment, the method includes the steps of (a) maneuvering the ROV through a three-dimensional space substantially occupied by a liquid, wherein the ROV moves along a particular flight path within a liquid storage tank for a first time period; (b) recording camera-based data during a second time period; and (c) recording sensor-based data during a third time period. Preferably, the first time period at least partially overlaps the second time period and the third time period, and the second time period at least partially overlaps the third time period. In one particular embodiment, the method further includes the step of (d) recording location data during a fourth time period wherein the fourth time period at least partially overlaps the first time period, the second time period, and the third time period.

Typically, the flight path of step (a) is based at least in part on the physical structure of the liquid storage tank holding the liquid within the three-dimensional space. The method may additionally or alternatively further include the step of displaying the camera-based data and the sensor-based data on a single display screen.

The method may also additionally or alternatively further include the step of setting a point of reference based on the location of the ROV when the reference point is set. The point of reference preferably is set based on the location of the ROV relative to the location of an object within the liquid storage tank.

The method may also additionally or alternatively further include the step of sanitizing the ROV and any associated materials that may enter the storage tank directly prior to or substantially as the ROV and any associated materials are introduced into the storage tank.

In a specific embodiment, step (b) further includes time stamping the camera-based data using an absolute time scale and step (c) further comprises time stamping the sensor-based data using the absolute time scale, whereby the camera-based data and the sensor-based data may be synchronized based on the absolute time scale.

In another specific embodiment, step (a) further includes transferring the camera-based data to a first transfer destination prior to recording the camera-based data, and transferring the sensor-based data to a second transfer destination prior to recording the sensor-based data. Preferably, the first transfer destination includes the second transfer destination.

In yet another embodiment, step (a) is performed wirelessly including wirelessly transferring the camera-based data to a first transfer destination prior to recording the camera-based data, and wirelessly transferring the sensor-based data to a second transfer destination prior to recording the sensor-based data; and/or wirelessly transferring the camera-based data to a first transfer destination prior to recording the camera-based data and wirelessly transferring the sensor-based data to a second transfer destination prior to recording the sensor-based data.

In one embodiment, step (a) further includes the steps of: (a)(1) maneuvering the ROV downward until the ROV is located proximate a lower seam of the storage tank; (a)(2) maneuvering the ROV proximate to and along the lower seam of the storage tank; (a)(3) maneuvering the ROV proximate a lower surface of the tank in a first repeating pattern; and (a)(4) maneuvering the ROV along a first portion of the wall of the tank in a second repeating pattern wherein the area included in the first portion of the wall of the tank is defined in part by the height of the second repeating pattern, wherein steps (a)(1), (a)(2), (a)(3), and (a)(4) can be taken in any chronological order. Step (a)(4) preferably further includes maneuvering the ROV along a second portion of the wall of the tank in the second repeating pattern. In a preferred embodiment, the second repeating pattern includes a pattern substantially resembling a sinusoidal wave. In at least one embodiment, the first repeating pattern includes a pattern formed from the steps including moving the ROV in a first linear path in a first direction until the ROV is proximate the wall of the tank, moving the ROV in a second direction substantially lateral to the first direction, moving the ROV in a third direction until the ROV is proximate the wall of the tank, wherein the third direction is oriented from about 140 degrees to about 220 degrees from the orientation of the first direction. In another embodiment, step (a)(2) is performed before step (a)(3) wherein the first repeating pattern includes a pattern in which the movement of the ROV from step (a)(2) is reversed in a diminished flight path that is substantially similar in shape to the shape of a flight path defined by the movement of the ROV in step (a)(2). In yet another embodiment, the second repeating pattern includes a corrugated pattern.

There are a number of advantages to the various embodiments of the present invention including providing a tool to gather and provide data that represent a plurality of actual conditions (as opposed to theoretical conditions) within a liquid storage tank.

One particular advantage in preferred embodiments is the provision of gathered sensor-based data, each sensor-based datum tied to a particular three-dimensional location within a storage tank. Preferably, each sensor-based datum is time-stamped or otherwise associated with a particular time value so that various sensor-based datum readings may be synchronized together based upon the time each datum was determined.

Another advantage of certain embodiments of the invention described herein is the display of sensor-based data and video-based data on a single display device. This allows a person viewing to see the actual view inside the tank at a particular time while, substantially simultaneously, seeing the data being sensed or otherwise recorded. One embodiment advantageously shows one or more trend graphs (e.g., line graphs of data versus time) on a display device along with video-based data, thereby giving a person viewing the display live (or viewing a recording of the data at a later time) a comprehensive view of what is (or was) happening within the liquid storage tank being monitored.

Yet another advantage of certain embodiments described herein includes providing an efficient method to map a liquid storage tank. A related advantage includes providing methods to map a liquid storage tank without entangling hardware with objects inside the mapped storage tank.

Another advantage of certain embodiments of the present invention include providing a heretofore unavailable library of information on the way liquids behave within various storage tanks, thereby allowing for a more detailed understanding of the effects of tank design, temperature control, and the control (or lack thereof) of other factors (e.g., pH, conductivity, total dissolved solids).

### BRIEF DESCRIPTION OF THE DRAWINGS

Features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a somewhat schematic view of a first embodiment of an ROV in a liquid tank;

FIG. 2 shows a somewhat schematic view of a second embodiment of an ROV in a liquid tank;

FIG. 3 shows an illustration of a ground storage tank;

FIG. 4 shows an illustration of a standpipe storage tank;

FIG. 5 shows an illustration of an elevated welded storage tank;

FIG. 6 shows an illustration of elevated composite storage tank;

FIG. 7 shows an illustration of an elevated spherical storage tank;

FIG. 8 shows an illustration of an elevated riveted storage tank;

FIG. 9 shows a somewhat schematic side view of a ground storage tank with arrows showing embodiments of flight patterns for an ROV;

FIG. 10 shows a somewhat schematic top-down view of a ground storage tank with arrows showing an embodiment of a flight pattern for an ROV;

FIG. 11 shows a somewhat schematic top-down view of a ground storage tank with arrows showing an embodiment of a flight pattern for an ROV;

FIG. 12 shows a somewhat schematic top-down view of a ground storage tank with arrows showing an embodiment of a flight pattern for an ROV, wherein the top of the tank is not shown, but a plurality of vents and a manway port are shown where they would be located along the top if it were present in the figure;

FIG. 13 shows a somewhat schematic side view of a ground storage tank with arrows showing embodiments of flight patterns for an ROV;

FIG. 14 shows a somewhat schematic side view of a ground storage tank with arrows showing embodiments of flight patterns for an ROV;

FIG. 15 shows a somewhat schematic top-down view of a ground storage tank with arrows showing an embodiment of a flight pattern for an ROV;

FIG. 16 shows an illustration of the inside of a dry tube, looking up through the top of a storage tank;

FIG. 17 shows an illustration of the inside of a dry tube, looking down into the dry tube from the top of a storage tank;

FIG. 18 shows an illustration of the outside of a dry tube looking from inside the storage compartment of a liquid storage tank;

FIG. 19 shows an illustration of a dry tube looking up into the storage compartment of a storage tank from within the storage tank;

FIG. 20 shows a somewhat schematic top-down view of an elevated storage tank with arrows showing an embodiment of a flight pattern for an ROV, wherein the top of the tank is not shown; and

FIG. 21 shows the top surface of an elevated storage tank including an aperture for gaining access to the interior of the storage tank.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense).
Absolute time scale: A time scale that includes an initial time value and equidistant time intervals (e.g., seconds) from the initial time value. For example, a Sensor A may begin collecting temperature measurements (one per second) starting at time t₀. Sensor B may begin collecting pressure measurements (one per second) starting at t₇. If the data collected by Sensor A were synchronized with the data collected by Sensor B with regard to time, the data would not co-exist synchronously until t₇ because it was not until t₇ that both Sensor A and Sensor B were collecting measurements.
Flight: a pattern of travel for an ROV or other similar device throughout space occupied by water or other liquid(s) or substance(s) in a storage tank.
Fly (verb): the act of travel through space occupied by liquid in a storage tank.
Inspection: the act of obtaining at least sensor-based and/or camera-based data related to a liquid storage tank.
Integrated: manufactured as a single unit or otherwise difficult and/or inconvenient to separate.
Liquidline: an imaginary substantially planar surface that corresponds with exposed surface of liquid stored within a storage tank.
Map (verb): the act of generating a map. Such map generation may include downloading experimental data retrieved during an inspection to a computing device running a software program wherein the data are expressed visually according to at least their type (e.g., temperature, pH), degree (e.g., temperature of 105° F., pH of 7.8), and/or spatial location (e.g., a location shown in a virtual storage tank on a display device associated with the computing device). These values need not be alphanumeric; for example, degree may be expressed by a color such as a dark red for a hot temperature and a light blue for a cool temperature.
Map (noun): a representation of conditions within a three dimensional space based on actual data generated from or otherwise based on sensor readings and/or visual data gathered from within the three dimensional space.
On-board: integrated term indicating the association of a first object to a second apparatus wherein the first object and the second object are proximate one another but are not “integrated” as defined herein.
Recording Medium: any means of recording data known to a person having ordinary skill in the art including, for example, a removable analogue tape, a digital hard drive, a removable disc, a removable digital tape, a RAM, a ROM, a jump drive, and an ASIC.
Sensor-based data: data collected by one or more types of sensors.
Video-based data: data collected by one or more types of video cameras.

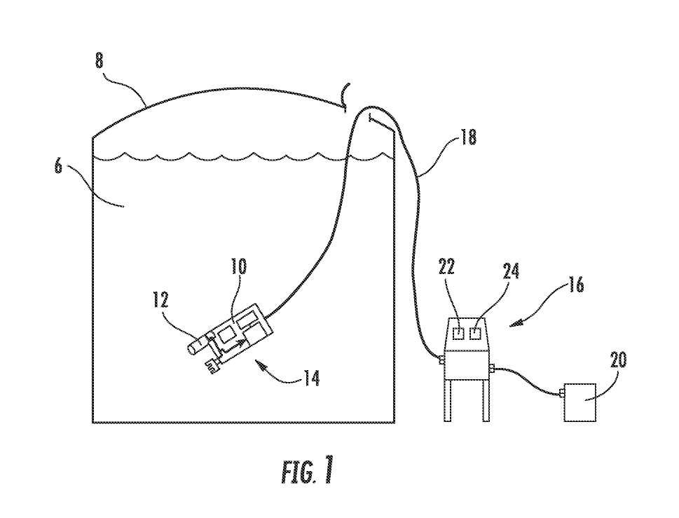

FIG. 1 shows a basic embodiment of a method of gathering data related to the actual condition of a liquid 6 (e.g., Water) contained within a liquid storage tank 8. The method uses a remote operated vehicle (ROV) 10 with video mounted equipment 12 for gathering camera-based (e.g., video) data and a sensor array 14 for gathering sensor-based data. The ROV 10 is preferably tethered and hard wired to a control station 16 by an extension connector 18. The control station 16 preferably includes a power source 20 that provides primary power to the ROV 10. The camera-based data and the sensor-based data may be transmitted to the control station 16 via the extension connector 18. The camera-based data and the sensor-based data may be viewed and recorded simultaneously, thereby providing a correlation between each sensor-based datum and the particular location of the ROV 10.

The embodiment shown in FIG. 1 includes the steps of (i) inserting the ROV 10 into the liquid 6 of the tank 8; (ii) maneuvering the ROV 10 through the liquid 6 for a first time period, following a particular flight pattern; (iii) recording the camera-based data during a second time period; and (iv) recording the sensor-based data during a third time period. A preferred step (v) includes setting a point of reference (e.g., the bottom of a ladder at or near the bottom surface of a tank) prior to steps iii and/or iv. Another preferred step (vi) includes periodically recording location data during a fourth time period, wherein the location data is based on the previously set point of reference as well as depth and heading information that is commonly tracked on modern submersibles known to a person having ordinary skill in the art. An example of such a submersible includes those sold by VideoRay, LLC of Phoenixville, Pa. Alternatively, GPS tracking may also be used to track the relative location of the ROV 10 as it moves through the liquid in a storage tank. Each datum recorded and/or transmitted from the ROV 10 is also preferably time stamped (i.e., each datum is recorded with an associated time) so that some or all of the various collections of data may be synchronized. Preferably, the second time period coincides with at least part of the first time period. Also, the third time period preferably coincides with at least part of the first time period and at least part of the second time period. Similarly, the fourth time period preferably coincides with at least part of the first time period, at least part of the second time period, and at least part of the third time period. Most preferably, the second time period coincides substantially directly with the third time period so that the recorded camera-based data may be synchronized with the sensor-based data for subsequent reporting or contemporaneous recording and/or observation.

In a preferred embodiment, the method described above further includes the steps of (vii) displaying the camera-based data on a first display screen 22 and (viii) displaying the sensor-based data on a second display screen 24. In a particularly preferred embodiment, the camera-based data and the sensor-based data are both displayed together on a single display screen so that it is not necessary to continually look back and forth from the first display screen 22 to the second display screen 24. Additionally or alternatively, an additional step (vii′) may include synchronizing the camera-based data with the sensor-based data and/or the location data. Additionally or alternatively, an additional step (vii″) may include synchronizing the sensor-based data with the camera-based data and/or the location data. A further optional step includes (ix) recording the synchronized data onto a recording medium.

The sensor array 14 preferably includes one or more sensors for gathering data related to, for example, free chlorine concentration, pH, liquid conductivity, total dissolved solids, temperature, and turbidity. An example of a sensor array that may be used includes the 600 XLM offered by YSI, Incorporated of Yellow Springs, Ohio. An example of an ROV that may be used includes the VideoRay Pro 3 offered by VideoRay, LLC of Phoenixville, Pa. The power source 20 may include, for example, a gas generator, a wall outlet, a car battery, or other similar power source known to a person having ordinary skill in the art. The camera-based data and the sensor-based data may be recorded on a removable recording media (e.g., a digital or analogue video recorder tape or disc, a flash drive, or other similar recording medium that is easily removable from the control station 16) or on an integrated recording medium such as a hard drive or any other physically integrated recording medium known to a person having ordinary skill in the art.

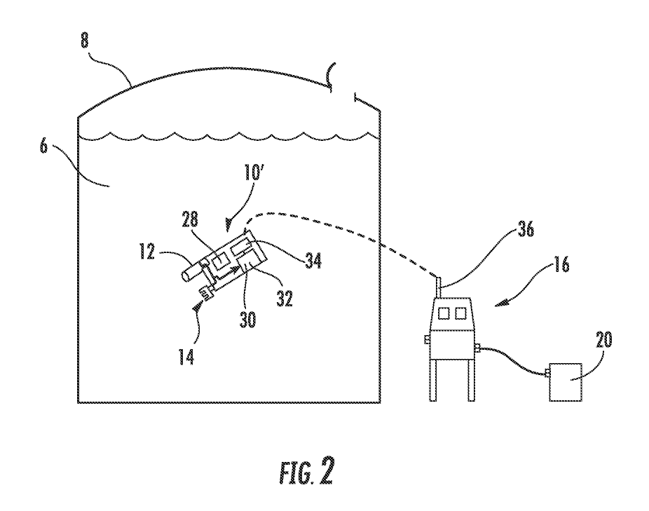

In an alternative embodiment shown in FIG. 2, an ROV 10′ may be controlled wirelessly, having no extension connector 18, but including an on-board primary power source 28 and an on-board memory storage module 30 for recording camera-based data and sensor-based data. The on-board power source may include, for example, a compact or semi-compact Lithium Ion battery, and the on-board memory storage module may include, for example, a flash drive with sufficient NVRAM memory storage capabilities (i.e., at least about 500 MB, preferably at least about 1 GB, and most preferably at least about 10 GB). Other similar hardware known to a person having ordinary skill in the art may be substituted. In one embodiment, the on-board memory storage module may include a volatile memory module 32 (e.g., a compact or semi-compact VRAM device) that is in communication with an on-board transmitter 34 for wirelessly transmitting the camera-based data and/or the sensor-based data to a wireless receiver 36 associated with the control station 16 for display and/or substantially permanent recordation on an appropriate recording medium.

In a related embodiment, the ROV 10′ may be fully autonomous including the on-board primary power source 28 and the on-board memory storage module 30 wherein the ROV 10′ collects the camera-based data and/or the sensor-based data on its own for a specific time period (e.g., until primary power is substantially exhausted or when an associated times out). The ROV 10′ may or may not include the extension connector 18. If the extension connector 18 is not included, the ROV 10′ preferably moves to the surface of the liquid 6 when an inspection flight has concluded.

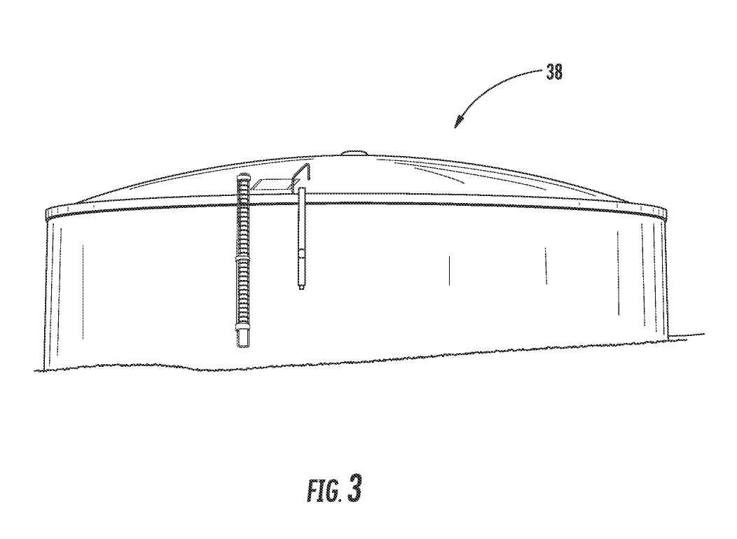

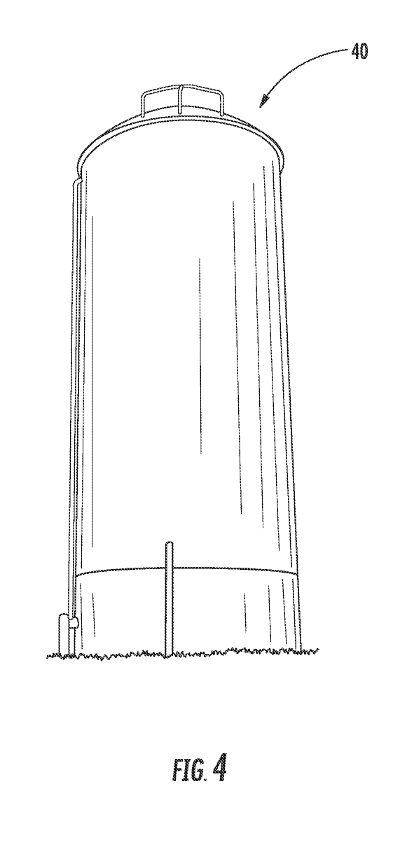

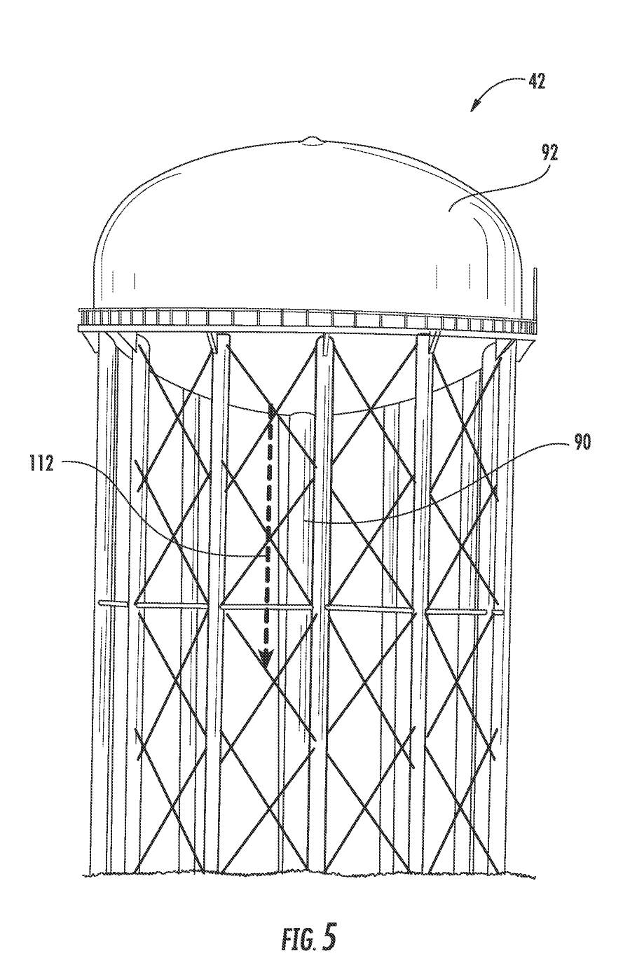

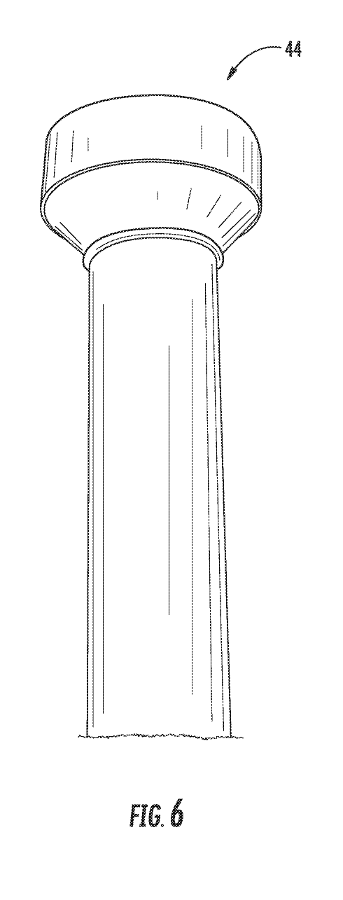

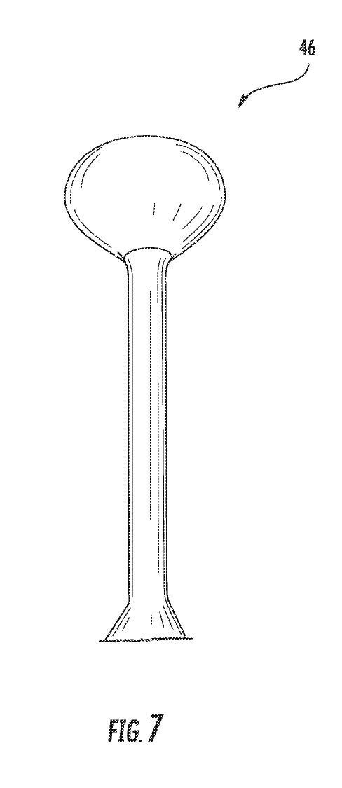

The flight pattern of an ROV is important because there are a wide range of liquid tank designs, each of which has its own technical and safety challenges for dynamic remote monitoring. Some examples of different tanks include ground storage tanks 38 as shown in FIG. 3, standpipe storage tanks 40 as shown in FIG. 4, elevated welded (external entry) storage tanks 42 as shown in FIG. 5, elevated composite (internal entry) storage tanks 44 as shown in FIG. 6, elevated spherical or “golf ball” type (internal entry) storage tanks 46 as shown in FIG. 7, and elevated riveted (external entry) storage tanks 48 as shown in FIG. 8. There are other types of liquid storage tanks, and the specific examples provided herein are not meant to be limiting. Each individual tank has its own set of internal obstacles which may include, for example, ladders (caged, partially caged, or un-caged), support columns (some including human access tubes), liquid level indicator systems, overflow pipe columns, cathode protection assemblies, interior baffles and/or curtains, other internal piping, and/or supplemental structures to support some or all of these exemplary types of structures. After placing an ROV inside an unfamiliar liquid storage tank, it is preferable to conduct a general visual sweep of the tank, obtain a substantially real-time view of the potential obstacles in such tank, and develop or alter a previously planned flight pattern for use with such tank.

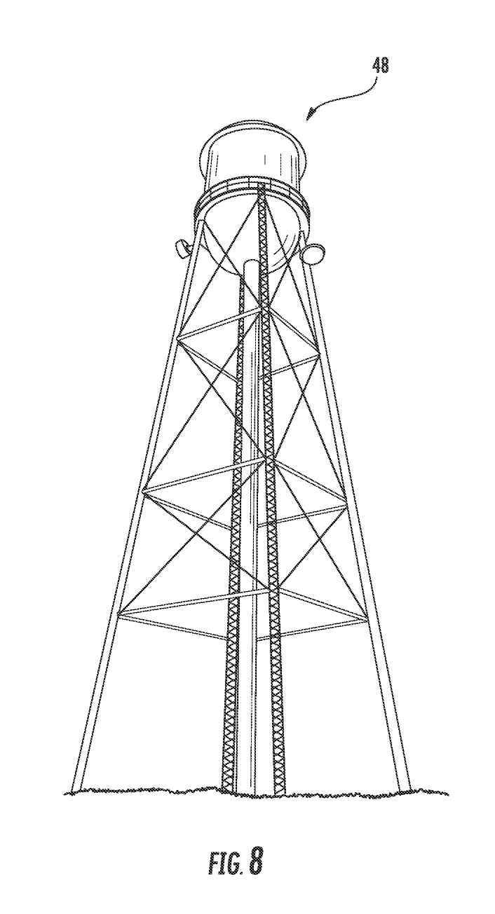

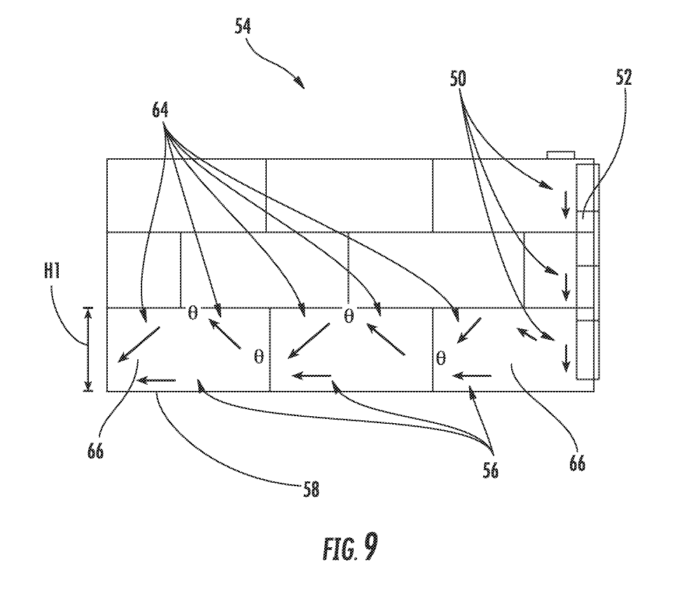

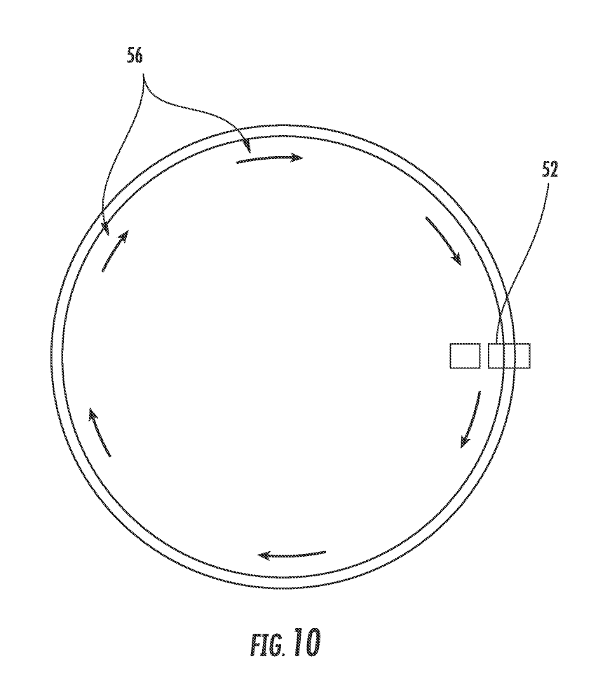

A preferred overall flight pattern for a ground storage tank includes a first flight pattern 50 shown in FIG. 9 which includes visually maneuvering the ROV 10 downward along a ladder 52 in a tank 54. Preferably, a point of reference is set when reaching the bottom of the ladder by, for example, noting location data. A second flight pattern 56 is shown in both FIG. 9 and FIG. 10 and includes maneuvering the ROV 10 around the lower seam 58 of the tank 54. A third flight pattern 60 shown in FIG. 11 includes maneuvering the ROV 10 back and forth in an orderly fashion along a lower surface 62 of the tank 54. A fourth flight pattern 64 shown in FIG. 9 and preferred for metal ground storage tanks includes maneuvering the ROV 10 in an alternating V-shaped and inverted V-shaped pattern along each horizontal set of metal panels 66 until the surface of the stored liquid is reached. The average height H1 of the “V” and inverted “V” shapes typically ranges from about six feet to about eight feet, and often depends on the height of the metal panels that were welded together to form the tank wall. Angles θ formed by the imaginary “V” shapes preferably range from about 75 degrees to about 105 degrees. The alternating V-shaped and inverted V-shaped pattern can also be expressed or envisioned as an imaginary sinusoidal pattern.

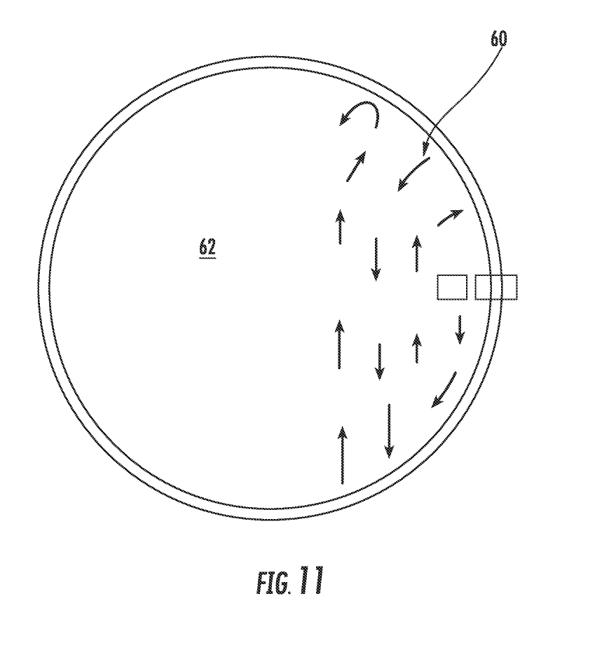

Certain storage tanks are considerably large and the extension member 18 may not be long enough to allow the ROV 10 to investigate substantially the entire storage tank. Thus, when a long enough extension member is not available, it becomes necessary to use an alternative overall flight pattern that is subdivided into halves or quadrants of the liquid volume held by a storage tank. In these types of situations, the investigation is broken down into two or more flights into a tank from different starting locations (i.e., apertures providing access to the tank above the liquid line). FIG. 12 shows a fifth flight pattern 68 for maneuvering the ROV 10 along the lower surface 70 of a tank 72. Access to the interior of the tank 72 is made possible via either the manway port 74 and/or, for example, one or more air vents 76 along the tank 72. A modified version of the fourth flight pattern 64 is used to move upward along a subdivision of the tank 72 wall that corresponds to that portion of the tank being investigated.

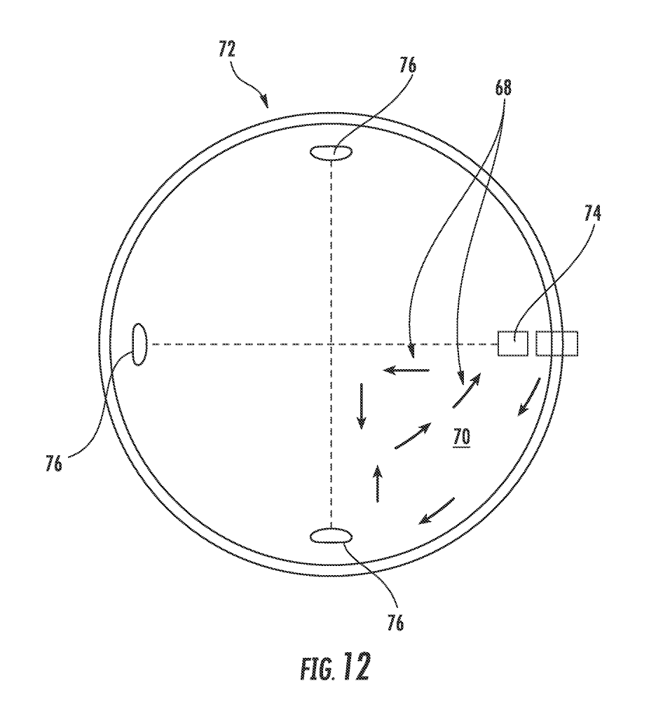

Preferred flight patterns for the ROV 10 in concrete ground storage tanks are very similar to those used for metal (e.g., welded) ground storage tanks. For example, the first flight pattern 50 shown in FIG. 9, the second flight pattern 56 shown in FIG. 10, and the third flight pattern 60 shown in FIG. 11 are all preferably used when investigating liquid storage tanks made primarily of concrete. However, a modified version of the fourth flight pattern 64 shown in FIG. 9—a sixth flight pattern 78—is used such that smaller “V” and inverted “V” shapes are traced during a flight as shown in FIG. 13. These smaller “V” and inverted “V” shapes also form angles θ that range from about 75 degrees to about 105 degrees and include an average height H2 that is about half or less than half of the average height H1 of the “V” and inverted “V” shapes flown in the fourth flight pattern 64 shown in FIG. 9. Again, the alternating V-shaped and inverted V-shaped pattern can also be expressed or envisioned as an imaginary sinusoidal pattern.

Additionally or alternatively, concrete storage tanks may be investigated using a seventh flight pattern 80 shown in FIG. 14. The seventh flight pattern 80 is used to investigate the walls of concrete storage tanks based on concrete storage tanks typically have substantially more horizontal cracking than metal storage tanks because of the way concrete storage tanks are commonly constructed.

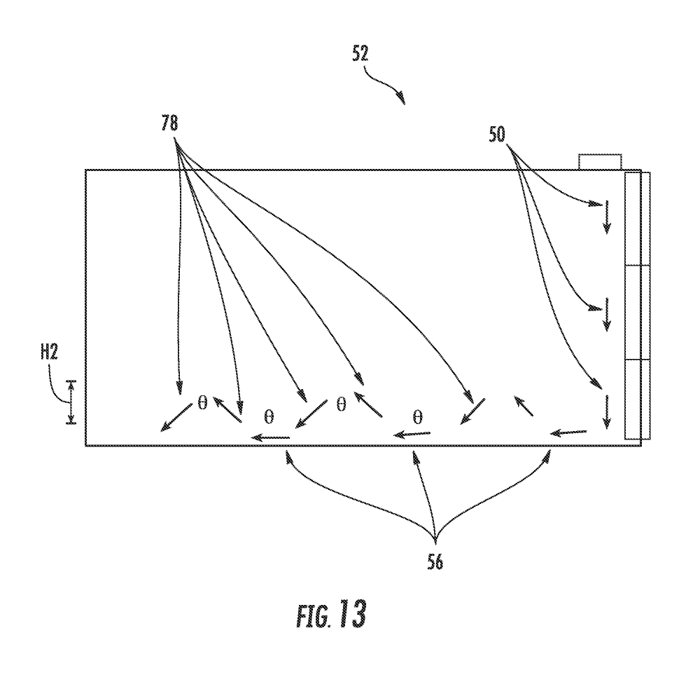

Some ground storage tanks include a center column. A center column 82 supporting a roof structure of a center-supported tank 84 is shown in FIG. 15. When the interior of the center-supported tank 84 is inspected, care must be taken to avoid entangling the extension connector 18 of the ROV with the center column 82. Thus, an eighth flight pattern 86 as shown in FIG. 15 is preferably used in lieu of the second flight pattern 56 and the third flight pattern 60. By repeatedly reversing the flight pattern of the ROV 10 as shown in FIG. 15, the chances of entangling the extension connector 18 and/or the ROV 10 with the center column 82 are reduced. Overall flight patterns for inspecting center supported tanks preferably include the first flight pattern 50 and the fourth flight pattern 64. Investigations conducted on center supported tanks also preferably include a ninth flight pattern 86 in which the ROV 10 is maneuvered to obtain camera-based data of the center column 82.

A primary difference between standpipe storage tanks and ground storage tanks is that almost all standpipe storage tanks are taller than they are wide. Otherwise, the basic geometry of standpipe storage tanks is very similar to that of ground storage tanks. A preferred overall flight pattern for a standpipe storage tank includes the first pattern 50, the second pattern 56, the third pattern 60, and the fourth pattern 64 described above and shown in FIGS. 9-11.

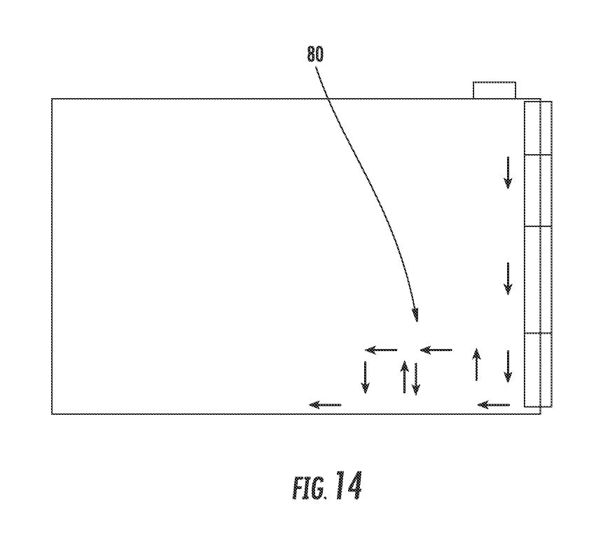

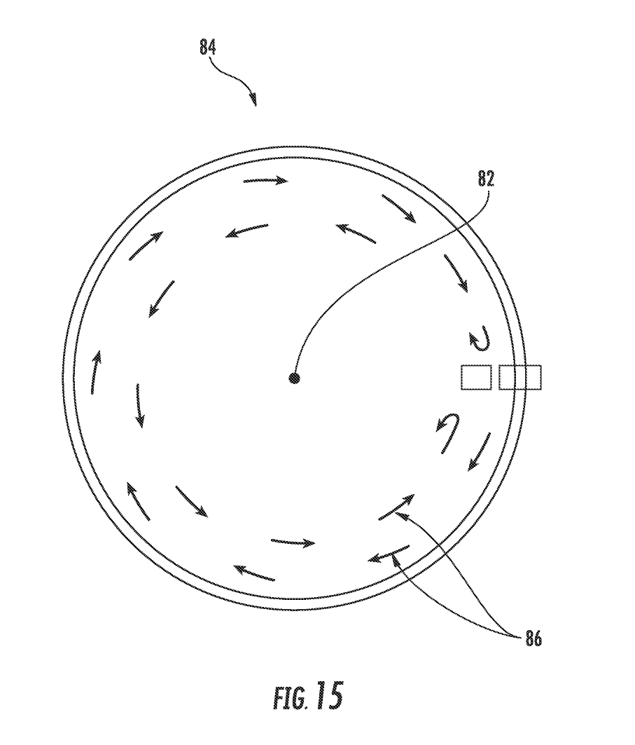

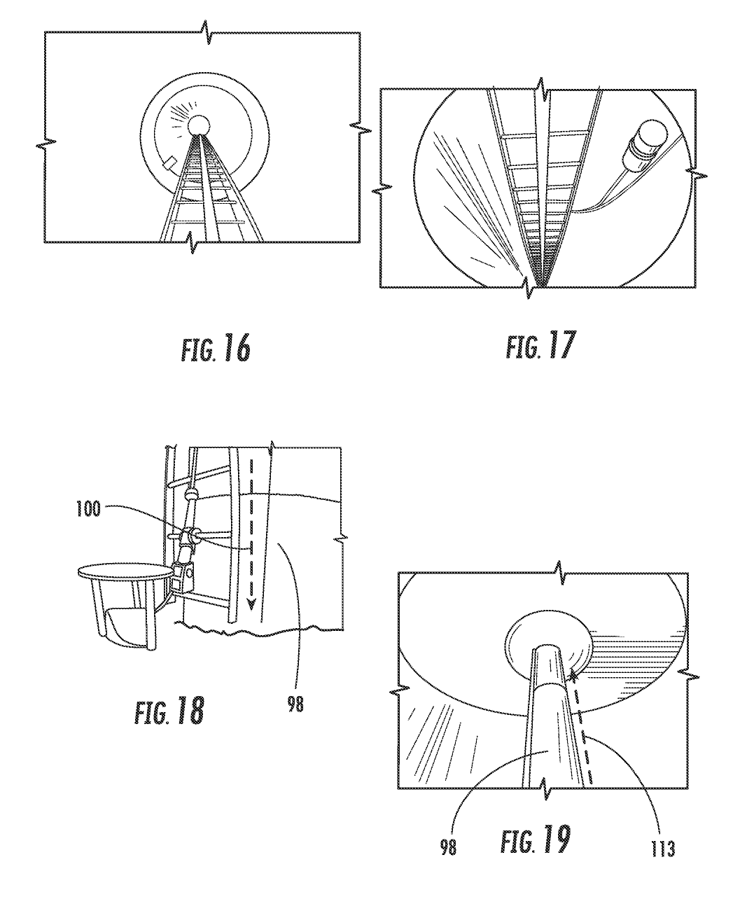

Elevated storage tanks differ from ground storage tanks in that elevated storage tanks are supported high above ground level by one or more support structures. For the purposes of this disclosure, the broad category of elevated liquid storage tanks is further sub-categorized as (1) external entry elevated storage tanks and (2) internal entry elevated storage tanks. A typical example of an elevated external entry storage tank 42 is shown in FIG. 5, the elevated storage tank 42 including a riser column 90 for supplying and removing liquid from a primary storage compartment 92. A composite liquid storage tank 44—an example of an internal entry elevated storage tank—is shown in FIG. 6. A spherical storage tank 46—another example of an internal entry elevated storage tank—is shown in FIG. 7. As shown in FIGS. 16-19, an important distinction between external entry elevated storage tanks and internal entry elevated storage tanks is that, in addition to a riser for supplying and removing liquid, the latter include what is commonly referred to as a “dry riser” or access tube 98 shown in FIGS. 18 and 19 that extends through the chamber storing liquid so that a person may climb or be lifted to the top of a tank.

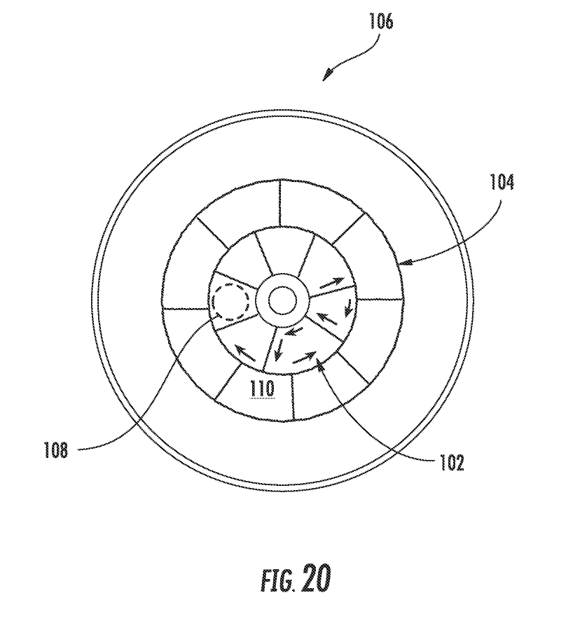

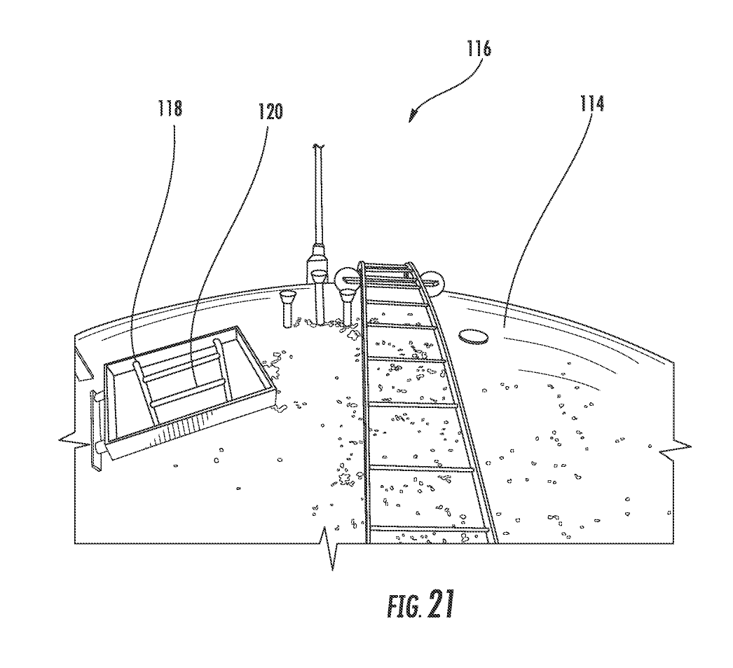

A preferred overall flight pattern for elevated storage tanks includes a tenth flight pattern 100 shown in FIG. 18 in which the ROV 10 is maneuvered down along a ladder (or other similar substantially vertically oriented structure inside a primary storage compartment). Then, a general sweep of the tank is preferably conducted to determine the location of any and all important structures. A eleventh flight pattern 102 is also preferably flown as shown in FIG. 20 in which the welds, riveted seams, and/or other structural lines of reference 104 within a tank 106 are substantially followed in polygonal and/or circular zigzag patterns 108 so as to avoid entanglement of the extension connector 18 with structures within the tank (e.g., the dry tube). The eleventh flight pattern 102 shown in FIG. 20 preferably starts from the lowermost and centermost area of a tank and migrates outwardly. If the tank 106 includes a separate vertically oriented wall, the fourth flight pattern 64 shown in FIG. 9 is preferably used to inspect such walls. If the tank 106 does not include a separate vertically oriented wall (e.g., in the case of an elevated spherical tank), the eleventh flight pattern 102 shown in FIG. 20 preferably is used to inspect substantially all of the interior panel surfaces 110 of the tank 106 that are wholly or partially below the liquidline.

A twelfth flight pattern 112 shown in FIG. 5 is preferably used to inspect a riser (i.e., a “wet riser”) in an external entry elevated storage tank. The twelfth flight pattern 112 includes allowing the ROV 10 to maneuver into the riser (preferably as low as possible) and obtain data.

A thirteenth flight pattern 113 shown in FIG. 19 is preferably used to inspect the exterior of a dry riser in an internal entry elevated storage tank, preferably starting from near the bottom of the dry riser and moving upward so as to avoid entanglement of the extension connector 18 with the dry riser.

In addition to the specific flight pattern desired to investigate a given storage tank, other considerations include the sanitation of the equipment, particularly when the storage tank being investigated is used to store potable water. For example, FIG. 21 shows the top surface 114 of a water storage tank 116 that is speckled with bird droppings near and around an access port 118 to the interior of the tank 120. It is reasonably foreseeable that an ROV and/or extension connector could easily come into contact with these or similar contaminants that could spread disease in potable water supplies prior to an inspection flight. Thus, it is necessary to include proper sanitation procedures when deploying an ROV in a potable water supply storage tank such as, for example, exposing the outer surface of the ROV and/or extension connector to a sodium hypochlorite solution (or some other acceptable agent known to persons having ordinary skill in the art that is capable of neutralizing harmful biological materials).

An important use of various embodiments described in this disclosure includes the inspection of liquid storage tanks wherein such inspections yield sensor-based data and camera-based data for many locations throughout the space occupied by liquid in a tank. By obtaining data throughout liquid stored within a liquid tank, a collection of empirical data may be obtained to more accurately model what the chemical and physical conditions are throughout a liquid storage tank. Additionally, individual tanks may be “mapped” (e.g., three-dimensionally illustrated) based on gathered data to show current conditions within a tank as well as any peculiar liquid behavior based on intriguing data results from within a tank. Such mapping allows for individual tanks and the liquid flow characteristics within them to be more thoroughly understood. A better understanding of the liquid behavior and conditions within storage tanks will inevitably lead to better storage tank design. The need for such a better understanding is rooted in the observation that liquid storage tanks are by no means static in nature. The physical and chemical conditions within a tank (and of the tank itself) are dynamic, and conditional fluctuations may be attributed to a number of factors including liquid demand, outside long-term temperature and pressure fluctuations (seasonal), outside short-term temperature and pressure fluctuations (hourly), and initial liquid quality (e.g., the quality of water when it is first introduced into a water storage tank). Thus, it is desirable to inspect liquid storage tanks at different times during the year to gain a better understanding of the characteristics of and conditions within a particular liquid storage tank. Using divers to accurately map a liquid tank and its contents, for example, during certain seasonal extremes is dangerous, sometimes impossible (e.g., due to extreme heat and/or the nature of the liquid), and cost prohibitive. The use of the apparatus and methods described herein are, therefore, a desirable alternative. Moreover, the specific flight patterns described herein are used to maximize use of tank inspection resources including, for example, ROV battery power (if applicable), as well as to maintain the ROV and associated equipment in good condition by avoiding unnecessary collisions and entanglements of the ROV within a tank.

With a more precise understanding of the activities and behaviors within a particular tank by using embodiments described herein, a number of improvements may be realized including higher stored liquid quality, more accurate diagnoses for primary and/or supplementary treatment of stored liquid, safer internal tank conditions, and safer structural tank conditions. Stored water quality, for example, would likely improve because the collection of data from the ROV would provide comprehensive information of water quality throughout the tank, leading to measures to correct and adjust conditions within a tank as needed. Diagnoses for water treatment, for example, within a tank, if any, would be made more accurate based on the substantially increased collection of data. Mapping of the internal parts of a tank would reveal otherwise hidden dangers that could endanger a future inspector and/or diver. The structural condition of a tank would be aided because the collection of data from the ROV would pinpoint undesired corrosion, cracking, or other problems earlier than visual inspection alone or sensor inspection at only one or a few locations within a tank. Additionally, a more efficient, clean, and thorough investigation of various tank conditions is achieved using embodiments described herein including (1) the requirement of only one overall device to be inserted into a tank to obtain a broad range of data, (2) virtually no direct human contact with stored liquid, (3) limited exposure of the stored liquid to the outside elements, and (4) no need for human entry into the storage compartment of liquid tanks which includes the inherent limitations (e.g., ability to gather data in extreme conditions for extended periods of time) and dangers (e.g., drowning, asphyxiation, and other risks associated with enclosed tank diving).

The foregoing description of preferred embodiments of the present invention has been presented for purposes of illustration and description. The showcased embodiments not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. A method of mapping a plurality of characteristics of a three-dimensional space substantially occupied by liquid within a liquid storage tank using a submersible remotely operated vehicle (ROV) equipped with a plurality of information collection components, the method comprising the steps of
a. maneuvering the ROV through a three-dimensional space substantially occupied by a liquid, wherein the ROV moves along a particular flight path within a liquid storage tank for a first time period;
b. recording camera-based data during a second time period; and
c. recording sensor-based data during a third time period;

2. The method of claim 1 wherein the first time period at least partially overlaps the second time period and the third time period, and wherein the second time period at least partially overlaps the third time period.

3. The method of claim 1 wherein the flight path of step (a) is based at least in part on the physical structure of the liquid storage tank holding the liquid within the three-dimensional space.

4. The method of claim 1 wherein step (b) further comprises time stamping the camera-based data using an absolute time scale and wherein step (c) further comprises time stamping the sensor-based data using the absolute time scale, whereby the camera-based data and the sensor-based data may be synchronized based on the absolute time scale.

5. The method of claim 1 wherein step (a) further comprises transferring the camera-based data to a first transfer destination prior to recording the camera-based data, and transferring the sensor-based data to a second transfer destination prior to recording the sensor-based data.

6. The method of claim 1 further comprising the step of displaying the camera-based data and the sensor-based data on a single display screen.

7. The method of claim 1 wherein step (a) further comprises wirelessly maneuvering the ROV through a three-dimensional space substantially occupied by a liquid, wherein the ROV moves along a particular flight path within a liquid storage tank for a first time period.

8. The method of claim 1 wherein step (a) further comprises setting a point of reference based on the location of the ROV when the reference point is set.

9. The method of claim 1 wherein step (a) further comprises the steps of: (a)(1) maneuvering the ROV downward until the ROV is located proximate a lower seam of the storage tank; (a)(2) maneuvering the ROV proximate to and along the lower seam of the storage tank; (a)(3) maneuvering the ROV proximate a lower surface of the tank in a first repeating pattern; and (a)(4) maneuvering the ROV along a first portion of the wall of the tank in a second repeating pattern wherein the area included in the first portion of the wall of the tank is defined in part by the height of the second repeating pattern, wherein steps (a)(1), (a)(2), (a)(3), and (a)(4) can be taken in any chronological order.

10. The method of claim 1 further comprising the step of sanitizing the ROV and any associated materials that may enter the storage tank directly prior to or substantially as the ROV and any associated materials are introduced into the storage tank.

11. The method of claim 2 further comprising the step of (d) recording location data during a fourth time period wherein the fourth time period at least partially overlaps the first time period, the second time period, and the third time period.

12. The method of claim 5 wherein the first transfer destination comprises the second transfer destination.

13. The method of claim 5 wherein step (a) further comprises wirelessly transferring the camera-based data to a first transfer destination prior to recording the camera-based data and wirelessly transferring the sensor-based data to a second transfer destination prior to recording the sensor-based data.

14. The method of claim 8 wherein the point of reference is set based on the location of the ROV relative to the location of an object within the liquid storage tank.

15. The method of claim 9 wherein step (a)(4) further comprises maneuvering the ROV along a second portion of the wall of the tank in the second repeating pattern.

16. The method of claim 9 wherein the second repeating pattern comprises a pattern substantially resembling a sinusoidal wave.

17. The method of claim 9 wherein the first repeating pattern comprises a pattern formed from the steps including moving the ROV in a first linear path in a first direction until the ROV is proximate the wall of the tank, moving the ROV in a second direction substantially lateral to the first direction, moving the ROV in a third direction until the ROV is proximate the wall of the tank, wherein the third direction is oriented from about 140 degrees to about 220 degrees from the orientation of the first direction.

18. The method of claim 9 wherein step (a)(2) is performed before step (a)(3) and wherein the first repeating pattern comprises a pattern in which the movement of the ROV from step (a)(2) is reversed in a diminished flight path that is substantially similar in shape to the shape of a flight path defined by the movement of the ROV in step (a)(2).

19. The method of claim 9 wherein the second repeating pattern comprises a corrugated pattern.

20. The method of claim 13 wherein step (a) further comprises wirelessly maneuvering the ROV through a three-dimensional space substantially occupied by a liquid within a liquid storage tank for a first time period and following a particular flight path.
